(19) United States
(12) Patent Application Publication
(10) Pub. No.: US 2018/0207060 A1
(43) Pub. Date: Jul. 26, 2018

(54) MOXIBUSTION DEVICE, METHOD AND SYSTEM FOR CONTROLLING SAME

(71) Applicant: BOE TECHNOLOGY GROUP CO., LTD., Beijing (CN)

(72) Inventor: Xueyun Wang, Beijing (CN)

(21) Appl. No.: 15/567,898

(22) PCT Filed: Apr. 14, 2017
(86) PCT No.: PCT/CN2017/080543

§ 371 Date: Oct. 19, 2017

(30) Foreign Application Priority Data
May 30, 2016 (CN) 201610369762.8

(51) Int. Cl. A61H 39/06

(52) U.S. Cl. CPC A61H 39/06; A61H 2205/00; A61H 2201/5082; A61H 2201/0184

(57) ABSTRACT

The present disclosure provides a moxibustion device, a method and a system for controlling the moxibustion device. The moxibustion device includes a box provided with at least one through-hole; a lid detachably connected to the box and cooperating with the box to define a combustion chamber where moxa is burnt, the lid being provided with at least one opening which cooperates with the through-hole in the box to define an air vent of the combustion chamber; a collection module provided within the combustion chamber and configured to collect one or more real-time state parameters of the moxa within the combustion chamber; a control module electrically connected to the collection module and configured to output a control instruction based on the one or more real-time state parameters collected by the collection module and one or more preset control parameters; and a drive module electrically connected to the control module and configured to adjust a size of the air vent based on the control instruction.

### CROSS-REFERENCE TO RELATED APPLICATION

This application is the U.S. national phase of PCT Application No. PCT/CN2017/080543 filed on Apr. 14, 2017, which claims priority to Chinese Patent Application No. 201610369762.8 filed on May 30, 2016, which are incorporated herein by reference in its entirety.

### TECHNICAL FIELD

The present disclosure relates to the field of temperature control technology, in particular to a moxibustion device, a method and a system for controlling the same.

### BACKGROUND

Moxibustion is a traditional Chinese medicine therapy which can adjust “yin” and “yang”, warm the meridian system and achieve a smoother flow of blood and “qi” through moxibustion at different acupoints. A portable moxibustion box, which is small in size, light in weight and easy to operate, is the first choice for family members who need special healthy treatment.

However, all the moxibustion boxes in related art rely on manual adjustment of their air vents to change the temperature, and it is difficult to find out how big the opening of the air vent needs to be to get the desired temperature and also difficult to maintain the moxibustion at a constant temperature.

### SUMMARY

In view of the above, embodiments of the present disclosure provide a moxibustion device, a method and a system for controlling the same so as to solve the technical problem in the related art that the temperature of moxibustion cannot be automatically controlled.

According to one aspect of the embodiments of the present disclosure, there is provided a moxibustion device including: a box provided with at least one through-hole; a lid detachably connected to the box and cooperating with the box to define a combustion chamber where moxa is burnt, the lid being provided with at least one opening which cooperates with the through-hole in the box to define an air vent of the combustion chamber; a collection module provided within the combustion chamber and configured to collect one or more real-time state parameters of the moxa within the combustion chamber; a control module electrically connected to the collection module and configured to output a control instruction based on the one or more real-time state parameters collected by the collection module and one or more preset control parameters; and a drive module electrically connected to the control module and configured to adjust a size of the air vent based on the control instruction.

In one possible embodiment of the present disclosure, the drive module is further configured to drive the box to rotate with respect to the lid based on the control instruction to adjust a size of an overlapping portion between the at least one through-hole and the at least one opening, so as to adjust the size of the air vent.

In one possible embodiment of the present disclosure, the moxibustion device further includes a wireless connection module electrically connected to the control module and configured to establish wireless connection with a terminal and to receive the one or more preset control parameters transmitted from the terminal and/or transmit the one or more real-time state parameters to the terminal subsequent to the establishment of the wireless connection.

In one possible embodiment of the present disclosure, the moxibustion device further includes a detection module electrically connected to the control module and configured to generate a warning message and/or a first turn-off instruction to turn off the moxibustion device when it is not operating properly.

In one possible embodiment of the present disclosure, the moxibustion device further includes a timepiece electrically connected to the control module and configured to time moxibustion based on the one or more control parameters and to generate an end reminder message and/or a second turn-off instruction to turn off the moxibustion device when a timing period of moxibustion has expired.

In one possible embodiment of the present disclosure, the box includes a first housing provided with the at least one through-hole, a partition, a second housing, a first accommodating space defined by the first housing and the partition, and a second accommodating space defined by the second housing and the partition, wherein the control module is mounted in the second accommodating space; the lid includes a third housing provided with the at least one opening, a top plate, and a third accommodating space defined by the third housing and the top plate, wherein the third accommodating space cooperates with the first accommodating space to define the combustion chamber.

In one possible embodiment of the present disclosure, the collection module includes a temperature sensor, the one or more real-time state parameters include a real-time temperature value within the combustion chamber, and the one or more control parameters include a predetermined temperature threshold; the control module includes a comparison unit configured to compare the predetermined temperature threshold and the real-time temperature value so as to obtain a real-time temperature difference, and an output unit configured to determine a required size of the air vent corresponding to the real-time temperature difference based on a corresponding relationship between a preset temperature difference and the size of the air vent and then output a control instruction for adjusting the size of the air vent based on a current size of the air vent and the required size of the air vent.

According to another aspect of the embodiments of the present disclosure, there is provided a method for controlling a moxibustion device that includes a box provided with at least one through-hole, and a lid detachably connected to the box and cooperating with the box to define a combustion chamber where moxa is burnt, the lid being provided with at least one opening which cooperates with the through-hole in the box to define an air vent of the combustion chamber, the control method including: acquiring one or more real-time state parameters of the moxa within the combustion chamber; outputting a control instruction based on the one or more real-time state parameters and one or more preset control parameters; and adjusting a size of the air vent based on the control instruction.

In one possible embodiment of the present disclosure, the adjustment of the size of the air vent based on the control instruction includes: driving the lid to rotate with respect to the box based on the control instruction to adjust a size of an overlapping portion between the at least one through-hole in the box and the at least one opening in the lid, so as to adjust the size of the air vent.

In one possible embodiment of the present disclosure, prior to the acquisition of the one or more real-time state parameter of the moxa within the combustion chamber, the method further includes: establishing wireless connection with a terminal; and receiving the one or more control parameters transmitted from the terminal and/or transmitting the one or more real-time state parameters to the terminal.

In one possible embodiment of the present disclosure, the method further includes: detecting whether the moxibustion device is operating properly; and transmitting a warning message to the terminal and/or turning off the moxibustion device when it is not operating properly.

In one possible embodiment of the present disclosure, prior to the detection of whether the moxibustion device is operating properly, the method further includes: determining whether a timing period of moxibustion of a timepiece predetermined based on the one or more control parameters has expired; and transmitting an end reminder message to the terminal and/or turning off the moxibustion device when the timing period of moxibustion has expired.

In one possible embodiment of the present disclosure, the one or more real-time state parameters include a real-time temperature value within the combustion chamber, and the one or more control parameters include a predetermined temperature threshold; and the outputting of the control instruction based on the one or more real-time state parameters and the one or more preset control parameters includes: comparing the predetermined temperature threshold and the real-time temperature value so as to obtain a real-time temperature difference; determining a required size of the air vent corresponding to the real-time temperature difference based on a corresponding relationship between a preset temperature difference and the size of the air vent; and outputting the control instruction for adjusting the size of the air vent based on a current size of the air vent and the required size of the air vent.

According to a third aspect of the embodiments of the present disclosure, there is provided a system including the moxibustion device as described above, and a terminal wirelessly connected to the moxibustion device and configured to transmit one or more control parameters to the moxibustion device and/or receive one or more real-time state parameters transmitted from the moxibustion device.

In one possible embodiment of the present disclosure, the system further includes a cloud server; the terminal is further configured to transmit historical data of moxibustion to the cloud server; and the cloud sever is configured to store the historical data of moxibustion transmitted from the terminal.

### BRIEF DESCRIPTION OF THE DRAWINGS

FIG. 1 is a schematic view of a box of a moxibustion device according to one of the embodiments of the present disclosure;

FIG. 2 is a schematic view of a lid of a moxibustion device according to one of the embodiments of the present disclosure;

FIG. 3 is a schematic view showing the cooperation between the lid and the box according to one of the embodiments of the present disclosure;

FIG. 4 is a schematic view showing mounting positions of respective functional modules in the moxibustion device according to one of the embodiments of the present disclosure;

FIG. 5 is a schematic view showing the principle of closed-loop temperature control according to one of the embodiments of the present disclosure;

FIG. 6 is a flow chart of a method for controlling the moxibustion device according to one of the embodiments of the present disclosure;

FIG. 7 is a flow chart of another method for controlling the moxibustion device according to one of the embodiments of the present disclosure;

FIG. 8 is a schematic view of a system for controlling the moxibustion device according to one of the embodiments of the present disclosure.

### DETAILED DESCRIPTION

Illustrative embodiments of the present disclosure will be described hereinafter in more details with reference to the drawings. While the illustrative embodiments of the present disclosure have been shown in the drawings, it should be understood that the present disclosure can be embodied in various forms and should not be limited to these illustrative embodiments. Rather, these embodiments are provided to enable a more thorough understanding of the present disclosure and to fully convey the scope of the present disclosure to those skilled in the art.

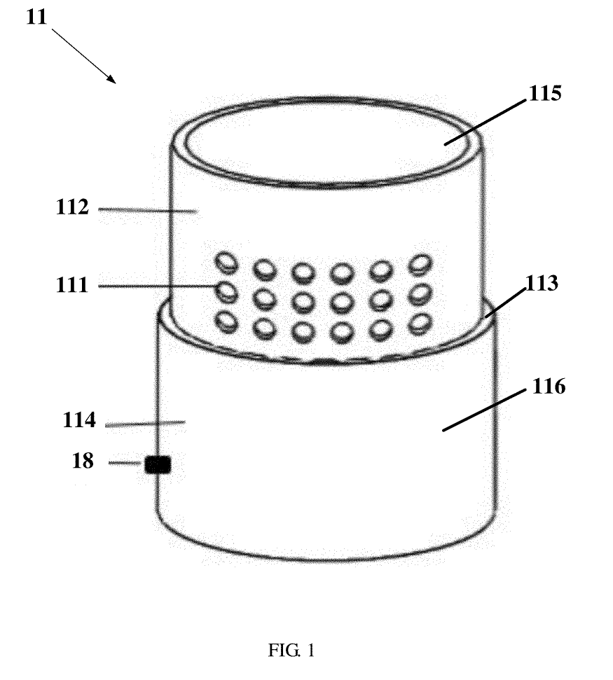

With reference to FIGS. 1 to 3, a moxibustion device in an embodiment of the present disclosure includes a box 11 and a lid 12, for example.

The box 11 is provided with at least one through-hole 111. In one possible embodiment of the present disclosure, a plurality of through-holes 111 are distributed in two opposing areas of the box 11, for example, eighteen through-holes 111 in each of the areas. As shown in FIG. 1, eighteen through-holes may be evenly distributed in the arrangement of three rows and six columns. However it should be noted that the number and position of the through-holes 111 are not limited in this embodiment.

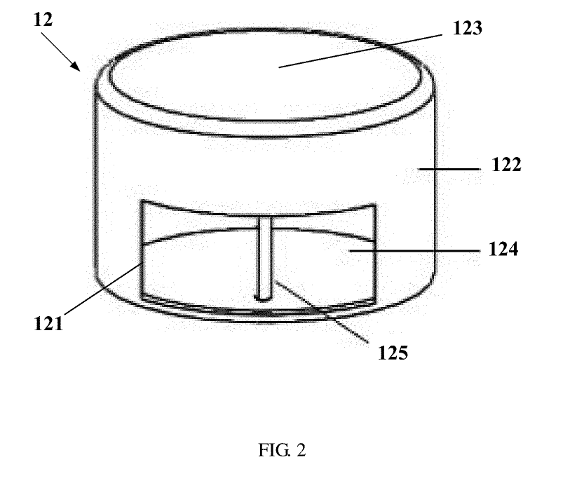

The lid 12 is detachably connected to the box 11. For example, the lid 12 is engaged with the box 11, and they cooperate with each other to define a combustion chamber 13. Referring to FIG. 2, the lid 12 is provided with at least one opening 121. In one possible embodiment of the present disclosure, at least one opening 121 is distributed in two opposing areas of the lid 12, for example, two openings provided in the lid 12 and each of the openings 121 capable of exposing a plurality of through-holes 111. The at least one through-hole 111 in the box 11 cooperates with the at least one opening 121 in the lid 12 to define an air vent 131 of the combustion chamber 13. The air vent 131 is configured to allow the combustion chamber 13 to communicate with the outside such that external air can enter into the combustion chamber 13 through the air vent 131. As a result, on one hand, oxygen necessary for the normal combustion of moxa can be provided, and on the other hand, cold air from the outside can enter into the combustion chamber 13. Of course, gas in the combustion chamber 13 (for example, flue gas generated by burning moxa) can also be discharged to the outside through the air vent 131 so as to prevent the temperature in the combustion chamber 13 from being excessively high.

Specifically, still referring to FIG. 1, the box 11 may include a first housing 112, a partition 113, a second housing 114, a first accommodating space 115 defined by the first housing 112 and the partition 113, and a second accommodating space 116 defined by the second housing 114 and the partition 113. The first housing 112 is provided with the at least one through-hole 111. In one possible embodiment of the present disclosure, at least one through-hole 111 is provided in each of two opposing areas of the first housing 112. Further, the partition 113 may be made of a thermal insulation material, and the second accommodating space 116 is equivalent to a thermal insulating chamber which may effectively protect circuit devices mounted therein, thus prolonging the service life of the moxibustion device.

Specifically, still referring to FIG. 2, the lid 12 may include a third housing 122, a top plate 123, and a third accommodating space 124 defined by the third housing 122 and the top plate 123, wherein the third accommodating space 124 cooperates with the first accommodating space 115 to define the combustion chamber 13. The third housing 122 is provided with at least one opening 121. In one possible embodiment of the present disclosure, at least one opening 121 is provided in each of two opposing areas of the third housing 122.

In this embodiment, to facilitate the fixation of the moxa, referring to FIG. 2, the lid 12 may further include a fixing portion 125 provided in the third accommodating space 124 and configured to fix the moxa, and one end of the fixing portion 125 may be fixed to the top plate 123.

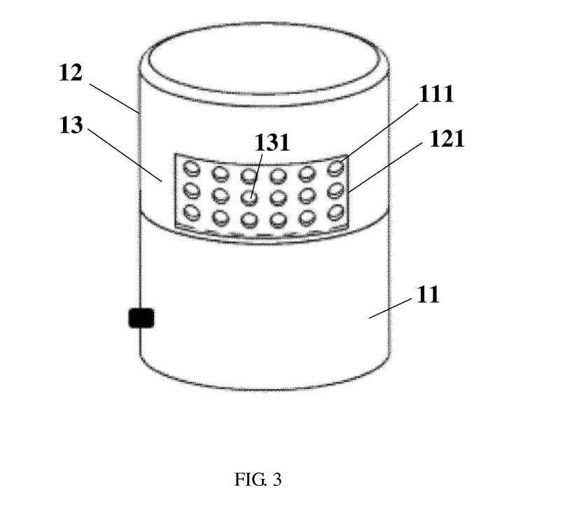

Still referring to FIG. 3, one opening 121 exposes eighteen (18) through-holes 111, and in this case the air vent 131 may be understood as having the largest ventilation area. If the ventilation area needs to be reduced, the number of the through-holes 111 exposed by the opening 121 may be reduced accordingly, for example, down to twelve (12) or six (6) or three (3). When the opening 121 does not expose any through-hole 111, it may be understood that the ventilation area of the air vent 131 is zero, that is, the combustion chamber 13 is a closed space.

Referring to FIG. 4, the moxibustion device further includes a collection module 14, a control module 15 and a drive module 16, wherein the collection module 14 is provided in the combustion chamber 13 and configured to collect one or more real-time state parameters (for example, a real-time combustion temperature or a combustion time) of the moxa (not shown in figures) within the combustion chamber 13. In one possible embodiment of the present disclosure, the collection module 14 may be a temperature sensor. It shall be noted that a specific type of the collection module 14 is not limited in this embodiment.

The control module 15 is electrically connected to the collection module 14 and configured to output a control instruction based on the one or more real-time state parameters collected by the collection module 14 and one or more preset control parameters. In one possible embodiment of the present disclosure, the preset control parameter may be a temperature threshold, and the control module 15 outputs a control instruction based on the real-time temperature collected by the collection module 14 and the preset temperature threshold. In one embodiment, the control module 15 may be a computing device such as a processor or a microcontroller.

It shall be noted that, the one or more preset control parameters may be other parameters such as time parameters, and are not limited in this embodiment. In one possible embodiment of the present disclosure, the control module 15 is mounted in the second accommodating space 116.

The drive module 16 is configured to adjust a size of an overlapping portion between the at least one through-hole 111 and the at least one opening 121 so as to adjust the size of the air vent 131. The drive module 16 is electrically connected to the control module 15.

In this embodiment, the larger the number of the through-holes 111 exposed by the opening 121 is, the larger the overlapping portion between the through-holes 111 and the opening 121 is, the larger the corresponding air vent 131 becomes. As opposed to it, the smaller the number of the through-holes 111 exposed by the opening 121 is, the smaller the overlapping portion between the through-holes 111 and the opening 121 is, and the smaller the corresponding air vent 131 becomes. Referring to FIG. 3, if the number of the through-holes 111 in the box 11 is eighteen (18), when the opening 121 exposes eighteen (18) through-holes 111, in this case the opening 121 and the through-hole 111 cooperatively define the largest air vent 131. Since the air vent 131 can enable cold air to enter into the combustion chamber 13 and gas in the combustion chamber 13 to be discharged from the air vent 131, the temperature in the combustion chamber 13 may be controlled by adjusting the size of the air vent 131 in this embodiment.

In one possible embodiment of the present disclosure, the drive module 16 is further configured to drive the box 11 to rotate with respect to the lid 12 based on the control instruction. For example, the drive module 16 is mounted on the lid 12 and drives the box 11 to rotate clockwise or counterclockwise with respect to the lid 12. Alternatively, the drive module 16 is configured to drive the lid 12 to rotate with respect to the box 11 based on the control instruction. For example, the drive module 16 is mounted on the box 11 and drives the lid 12 to rotate clockwise or counterclockwise with respect to the box 11 to adjust a size of an overlapping portion between the at least one through-hole 111 and the at least one opening 121, so as to adjust the size of the air vent 131. For example, the drive module 16 may be a step motor and of course, is not limited thereto.

When the drive module 16 is a step motor, the control instruction may be an instruction to drive the step motor to rotate clockwise or counterclockwise, and the clockwise or counterclockwise rotation of the step motor may increase or decrease the air vent 131, thereby adjusting the temperature in the combustion chamber 13.

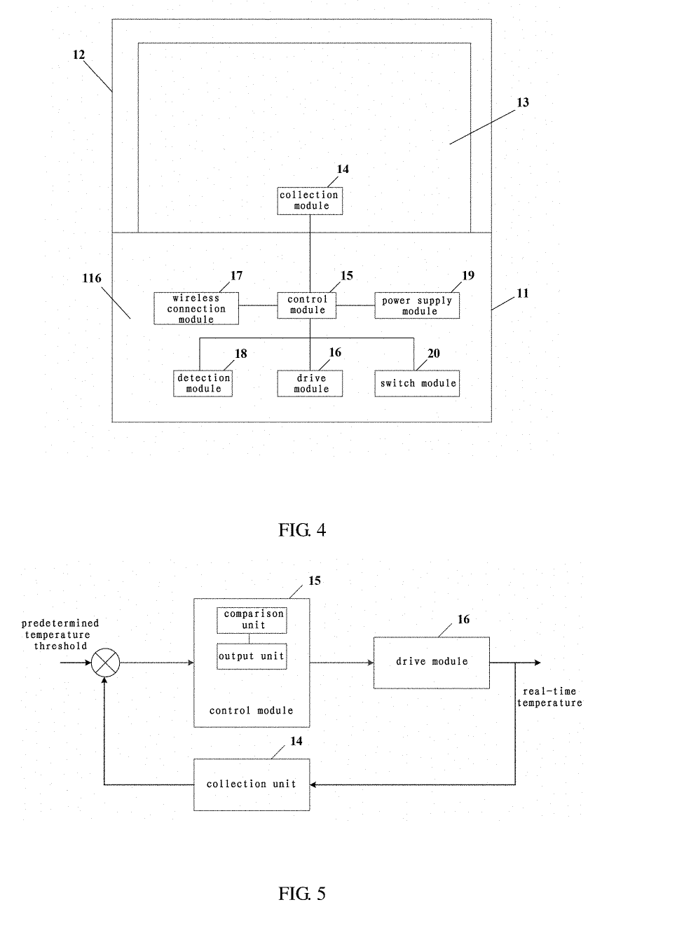

Referring to FIG. 5 which shows the principle of close-loop temperature control in this embodiment, the collection module 14 includes a temperature sensor which collects one or more real-time state parameters including a real-time temperature value in the combustion chamber 13. The one or more preset control parameters include a predetermined temperature threshold. The control module 15 includes a comparison unit and an output unit, wherein the comparison unit is configured to compare the predetermined temperature threshold and the real-time temperature value so as to obtain a real-time temperature difference, and the output unit is configured to determine a required size of the air vent corresponding to the real-time temperature difference based on a corresponding relationship between a preset temperature difference and the size of the air vent and then output, to the drive module 16, a control instruction for adjusting the size of the air vent based on a current size of the air vent and the required size of the air vent.

For example, when the real-time temperature difference is a positive number, a control instruction for reducing the overlapping portion between the at least one through-hole 111 and the at least one opening 121 (equivalent to reducing the air vent 131) is outputted to the drive module 16. In one possible embodiment of the present disclosure, when the real-time temperature difference is between +0.5° C. and +1° C., it corresponds to reducing three through-holes 111, and when the real-time temperature difference is between +1° C. and +2° C., it corresponds to reducing six through-holes 111, and further, if the size of the air vent is reduced to the smallest or increased to the largest, an alarm reminder may be given. However, the cases are not limited thereto.

When the real-time temperature difference is a negative number, a control instruction for increasing the overlapping portion between the at least one through-hole 111 and the at least one opening 121 (equivalent to increasing the air vent 131) is outputted to the drive module 16. In one possible embodiment of the present disclosure, when the real-time temperature difference is between −0.5° C. and −1° C., it corresponds to increasing three through-holes 111, and when the real-time temperature difference is between −1° C. and −2° C., it corresponds to increasing six through-holes 111, and further, if the size of the air vent is reduced to the smallest or increased to the largest, an alarm reminder may be given. However, the cases are not limited thereto.

In this embodiment, the collection module collects one or more real-time state parameters of the moxa within the combustion chamber, and the control module then outputs a control instruction based on the one or more real-time state parameters and one or more preset control parameters to achieve automatic control of the temperature of moxibustion and avoid a big error, slow response and other issues due to manual adjustment of the size of the opening of the moxibustion device for the purpose of controlling the temperature in the related art.

Still referring to FIG. 4, the moxibustion device in this embodiment includes a wireless connection module 17 electrically connected to the control module 15 and configured to establish wireless connection with a terminal (not shown in the figures) and to receive the one or more control parameters transmitted from the terminal and transmit the one or more real-time state parameters to the terminal subsequent to the establishment of the wireless connection.

In this embodiment, in order to improve the operability and user experience of moxibustion, wireless connection is established with the terminal through the wireless connection module, and the terminal may transmit one or more control parameters to the moxibustion device. Still referring to FIG. 4, the moxibustion device further includes a detection module 18 electrically connected to the control module 15 and configured to detect whether the moxibustion device is operating properly and to generate a warning message (such as a text warning reminder or a sound warning reminder) and/or a first turn-off instruction to turn off the moxibustion device when it is not operating properly. Accordingly the control module 15 controls the wireless connection module 17 to transmit the warning message to the terminal, or turns off the moxibustion device after receiving the first turn-off instruction.

In one embodiment, the detection module 18 may be a sensor for detecting at least one of whether the control module 15 fails, whether the collection module 14 fails, and whether the drive module 16 fails, so as to determine whether the moxibustion device is operating properly.

In this embodiment, in order to further improve the safety protection function, the detection module 18 is used to detect whether the moxibustion device is operating properly and to give a warning (such as a text warning reminder or a sound warning reminder) and/or turn off the moxibustion device when it is not operating properly. As a result, the safety and reliability of moxibustion are improved.

In one possible embodiment of the present disclosure, the moxibustion device further includes a timepiece (not shown in the figures) electrically connected to the control module 15. The timepiece is configured to time moxibustion based on the one or more control parameters and to generate an end reminder message (such as a text reminder or a sound reminder) and/or a second turn-off instruction to turn off the moxibustion device when a timing period of moxibustion has expired. The control module 15 controls the wireless connection module 17 to transmit the end reminder message to the terminal, or turns off the temperature-adjustable moxibustion device after receiving the second turn-off instruction.

In this embodiment, in order to further improve the safety protection function, the timepiece is used to detect whether the timing period of moxibustion has expired. And when the timing period of moxibustion has expired, a reminder (such as a text reminder or a sound reminder) is given and/or the moxibustion device is turned off. As a result, the safety and reliability of moxibustion can be further improved.

Still referring to FIG. 4, the moxibustion device further includes a power supply module 19 and a switch module 20, wherein the power supply module 19 is electrically connected to and configured to supply power to the collection module 14, the control module 15 and the drive module 16; and the switch module 20 is electrically connected to the control module 15. In one embodiment, the power supply module 19 may be a button battery or a small-size dry battery so as to improve the portability of the moxibustion device.

The embodiments of the present disclosure achieve the following advantageous effects, including: the one or more real-time state parameters of the moxa within the combustion chamber are collected, the control instruction is then outputted based on the collected one or more real-time state parameters and the one or more preset control parameters, and the size of the overlapping portion between the at least one through-hole and the at least one opening is adjusted based on the control instruction. As a result, it is able to adjust the size of the air vent, achieve automatic control of the temperature of moxibustion and avoid a big error, slow response and other issues due to manual adjustment of the size of the opening of the moxibustion box for the purpose of controlling the temperature.

Further, in this embodiment, in order to improve the operability and user experience of moxibustion, the moxibustion device may establish wireless connection with the terminal and the terminal may transmit the one or more control parameters to the moxibustion device or receive and display the one or more real-time state parameters transmitted from the moxibustion device. Moreover, the terminal may collect and store the history of moxibustion locally or on a cloud server, allowing users to check the saved history of moxibustion whenever and wherever possible.

Further, in this embodiment, in order to improve the safety protection function, whether the moxibustion device is operating properly may be detected. And when the moxibustion device is not operating properly, a warning may be given and/or the moxibustion device may be turned off. As a result, the safety and reliability of moxibustion are improved.

Further, in this embodiment, in order to improve the safety protection function, a timepiece may be used to detect whether a timing period of moxibustion has expired. And when the timing period of moxibustion has expired, a reminder may be given and/or the moxibustion device may be turned off. As a result, the safety and reliability of moxibustion are improved.

One of the embodiments of the present disclosure further provides a method for controlling a moxibustion device that includes a box provided with at least one through-hole, and a lid detachably connected to the box and cooperating with the box to define a combustion chamber where moxa is burnt, the lid being provided with at least one opening which cooperates with the through-hole in the box to define an air vent of the combustion chamber. It shall be noted that the aforementioned embodiments may be referred to for the contents relating to the structure of the moxibustion device in this embodiment, which will not be repeated here.

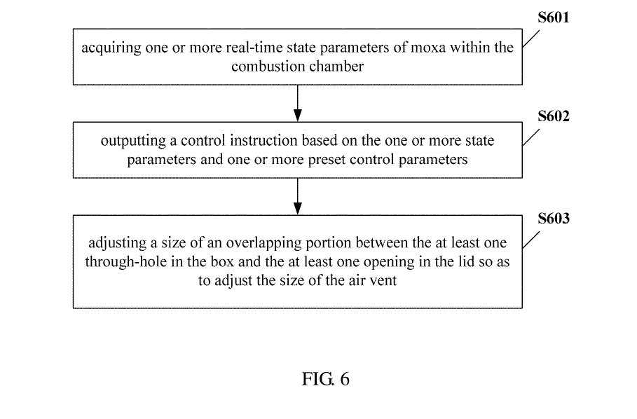

Referring to FIG. 6 which shows a method for controlling the moxibustion device, the method includes the following steps.

In step S601, one or more real-time state parameters of moxa within the combustion chamber are acquired.

In one possible embodiment of the present disclosure, the one or more real-time state parameters include at least one of a real-time temperature value in the combustion chamber and a combustion time value.

In step S602, a control instruction is outputted based on the one or more real-time state parameters and one or more preset control parameters.

Below, the real-time temperature value in the combustion chamber will be taken as an example of the real-time state parameter acquired in step S601.

In step S602, a predetermined temperature threshold is compared with the real-time temperature value to obtain a real-time temperature difference; a required size of the air vent corresponding to the real-time temperature difference is determined based on a corresponding relationship between a preset temperature difference and the size of the air vent; and a control instruction for adjusting the size of the air vent is outputted based on a current size of the air vent and the required size of the air vent. For example, when the real-time temperature difference is a positive number, a control instruction for reducing the overlapping portion between the at least one through-hole and the at least one opening (equivalent to reducing the air vent) is outputted. In one possible embodiment of the present disclosure, when the real-time temperature difference is between +0.5° C. and +1° C., it corresponds to reducing three through-holes; and when the real-time temperature difference is between +1° C. and +2° C., it corresponds to reducing six through-holes; and further, if the size of the air vent is reduced to the smallest or increased to the largest, an alarm reminder may be given. However, the cases are not limited thereto.

When the real-time temperature difference is a negative number, a control instruction for increasing the overlapping portion between the at least one through-hole and the at least one opening (equivalent to increasing the air vent) is outputted. In one possible embodiment of the present disclosure, when the real-time temperature difference is between −0.5° C. and −1° C., it corresponds to the increase of three through-holes; and when the real-time temperature difference is between −1° C. and −2° C., it corresponds to the increase of six through-holes; and further, if the size of the air vent is reduced to the smallest or increased to the largest, an alert may be given. However, the cases are not limited thereto.

It shall be noted that, if the real-time state parameter is the combustion time, the combustion time is compared with a preset combustion time in step S602 to obtain a time difference, a required size of the air vent corresponding to the current time difference is then determined based on a corresponding relationship between a preset time difference and the size of the air vent. And then a control instruction for adjusting the size of the air vent is outputted based on a current size of the air vent and the required size of the air vent. For example, a control instruction for reducing the size of the air vent may be outputted if the combustion time exceeds the preset combustion time. On the other hand, another control instruction for increasing the size of the air vent or keeping the size of the air vent unchanged may be outputted if the combustion time does not exceed the preset combustion time.

In step S603, a size of an overlapping portion between the at least one through-hole in the box and the at least one opening in the lid is adjusted based on the control instruction so as to adjust the size of the air vent.

Specifically, the box is driven to rotate with respect to the lid based on the control instruction or the lid is driven to rotate with respect to the box based on the control instruction to adjust the size of the overlapping portion between the at least one through-hole in the box and the at least one opening in the lid, so as to adjust the size of the air vent.

In this embodiment, the one or more real-time state parameters of the moxa within the combustion chamber are acquired, and the control instruction is then outputted based on the acquired one or more state parameters and the one or more preset control parameters. As a result, it is able to achieve automatic control of the temperature of moxibustion and avoid a big error, slow response and other issues due to manual adjustment of the size of the opening of the moxibustion box for the purpose of controlling the temperature in the related art.

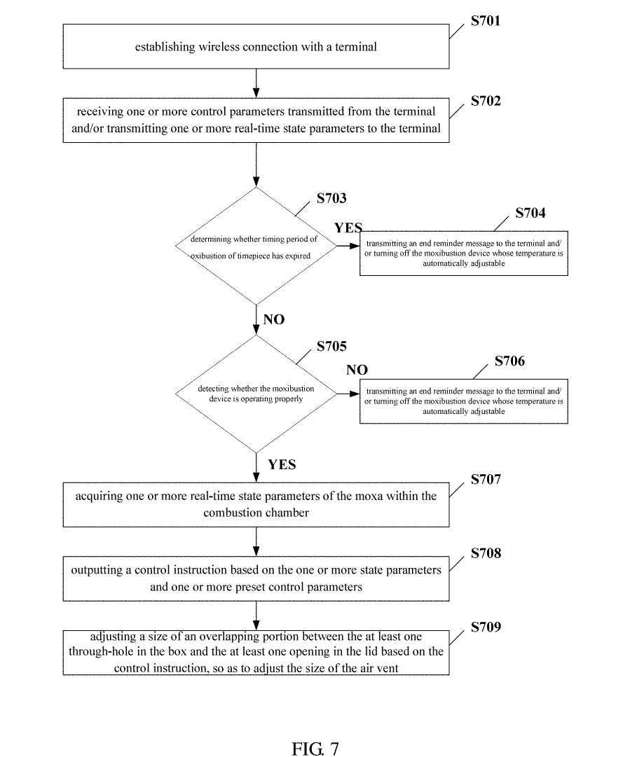

Referring to FIG. 7 which shows a method for controlling a moxibustion device, steps are given as follows:

step S701: establishing wireless connection with a terminal and then proceeding to step S702; [0073] step S702: receiving one or more control parameters transmitted from the terminal and/or transmitting one or more real-time state parameters to the terminal;

step S703: determining whether a timing period of moxibustion of a timepiece predetermined based on the one or more control parameters has expired, and if yes, proceeding to step S704; or otherwise, proceeding to step S705;

step S704: transmitting an end reminder message to the terminal and/or turning off the moxibustion device;

step S705: detecting whether the moxibustion device is operating properly, and if not, proceeding to step S706, and if yes, proceeding to step S707;

step S706: transmitting a warning message to the terminal and/or turning off the moxibustion device;

step S707: acquiring one or more real-time state parameters of the moxa within the combustion chamber and then proceeding to step S708;

step S708: outputting a control instruction based on the one or more state parameters and one or more preset control parameters and then proceeding to step S709; for example, the one or more real-time state parameters include a real-time temperature value within the combustion chamber, and the one or more control parameters include a predetermined temperature threshold, and correspondingly, the predetermined temperature threshold is compared with the real-time temperature value in step S708 to obtain a real-time temperature difference; a required size of the air vent corresponding to the real-time temperature difference is determined based on a preset temperature difference and the size of the air vent; and a control instruction for adjusting the size of the air vent is outputted based on a current size of the air vent and the required size of the air vent; and

step S709: adjusting a size of an overlapping portion between the at least one through-hole in the box and the at least one opening in the lid based on the control instruction, so as to adjust the size of the air vent.

In this embodiment, in order to improve the operability and user experience of moxibustion, the moxibustion device may establish wireless connection with the terminal and the terminal may transmit the one or more control parameters to the moxibustion device.

In this embodiment, in order to improve the safety protection function, whether the moxibustion device is operating properly may be detected, and when the moxibustion device is not operating properly, a warning may be given and/or the moxibustion device may be turned off. As a result, the safety and reliability of moxibustion are improved. In order to further improve the safety protection function, a timepiece may be used to detect whether a timing period of moxibustion has expired, and when the timing period of moxibustion has expired, a reminder may be given and/or the moxibustion device may be turned off. As a result, the safety and reliability of moxibustion are improved. Then, the one or more real-time state parameters of the moxa within the combustion chamber are collected, the control instruction is outputted based on the collected one or more real-time state parameters and the one or more preset control parameters, and the size of the overlapping portion between the at least one through-hole and the at least one opening is adjusted based on the control instruction. As a result, it is able to adjust the size of the air vent, achieve automatic control of the temperature of moxibustion and avoid a big error, slow response and other issues due to manual adjustment of the size of the opening of the moxibustion box for the purpose of controlling the temperature in the related art.

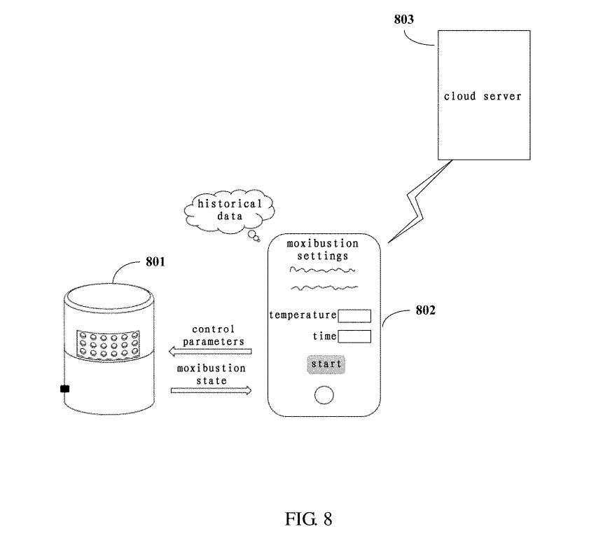

Referring to FIG. 8 which shows a system including the moxibustion device 801 as described above and a terminal 802 wirelessly connected to the moxibustion device. The terminal 802 is configured to transmit one or more control parameters to the moxibustion device 801 and/or receive the one or more real-time state parameters transmitted from the moxibustion device 801.

The terminal 802 may include a wireless module, a display unit and a loudspeaker. The display unit is configured to display the one or more real-time state parameters received by the wireless module, or display a text warning reminder. And the loudspeaker is configured to generate a sound warning reminder, and may give a warning reminder for example when the size of the air vent is reduced to the smallest or increased to the largest.

In one possible embodiment of the present disclosure, the system further includes a cloud server 803. The terminal 802 is further configured to transmit historical data of moxibustion to the cloud server 803. And the cloud server 803 is configured to store the historical data of moxibustion transmitted from the terminal 802.

This embodiment of the present disclosure achieves the following advantageous effects: the one or more real-time state parameters of the moxa within the combustion chamber are collected, the control instruction is then outputted based on the collected one or more real-time state parameters and the one or more preset control parameters, and the size of the overlapping portion between the at least one through-hole and the at least one opening is adjusted based on the control instruction. As a result, it is able to adjust the size of the air vent, achieve automatic control of the temperature of moxibustion and avoid a big error, slow response and other issues due to manual adjustment of the size of the opening of the moxibustion box for the purpose of controlling the temperature in the related art.

Further, in this embodiment, in order to improve the operability and user experience of moxibustion, the moxibustion device may establish wireless connection with the terminal and the terminal may transmit the one or more control parameters to the moxibustion device.

Further, in this embodiment, in order to improve the safety protection function, whether the moxibustion device is operating properly may be detected. And when the moxibustion device is not operating properly, a warning may be given or the moxibustion device may be turned off. As a result, the safety and reliability of moxibustion are improved.

Further, in this embodiment, in order to further improve the safety protection function, a timepiece may be used to detect whether a timing period of moxibustion has expired. And when the timing period of moxibustion has expired, a reminder may be given or the moxibustion device may be turned off. As a result, the safety and reliability of moxibustion are improved.

In one embodiment, the terminal may be applied to mobile phones, tablets or laptops.

The above are preferred embodiments of the present disclosure, and it shall be indicated that those having ordinary skills in the art may make improvements and modifications without departing from the principle of the present disclosure, and such improvements and modifications also fall within the scope of the present disclosure.

1. A moxibustion device, comprising:
a box provided with at least one through-hole;
a lid detachably connected to the box and cooperating with the box to define a combustion chamber where moxa is burnt, the lid being provided with at least one opening which cooperates with the through-hole in the box to define an air vent of the combustion chamber;
a collection module provided within the combustion chamber and configured to collect one or more real-time state parameters of moxa within the combustion chamber;
a control module electrically connected to the collection module and configured to output a control instruction based on the one or more real-time state parameters collected by the collection module and one or more preset control parameters; and
a drive module electrically connected to the control module and configured to adjust a size of the air vent based on the control instruction.

2. The device according to claim 1, wherein the drive module is further configured to drive the lid to rotate with respect to the box based on the control instruction to adjust a size of an overlapping portion between the at least one through-hole and the at least one opening, so as to adjust the size of the air vent.

3. The device according to claim 1, further comprising a wireless connection module electrically connected to the control module and configured to establish wireless connection with a terminal and to receive the one or more preset control parameters transmitted from the terminal and/or transmit the one or more real-time state parameters to the terminal subsequent to the establishment of the wireless connection.

4. The device according to claim 3, further comprising a detection module electrically connected to the control module and configured to generate a warning message and/or a first turn-off instruction to turn off the moxibustion device when the moxibustion device is not operating properly.

5. The device according to claim 4, further comprising a timepiece electrically connected to the control module and configured to time moxibustion based on the one or more control parameters and to generate an end reminder message and/or a second turn-off instruction to turn off the moxibustion device when a timing period of moxibustion has expired.

6. The device according to claim 1, wherein the box comprises a first housing provided with the at least one through-hole, a partition, a second housing, a first accommodating space defined by the first housing and the partition, and a second accommodating space defined by the second housing and the partition, wherein the control module is mounted in the second accommodating space; and
wherein the lid comprises a third housing provided with the at least one opening, a top plate, and a third accommodating space defined by the third housing and the top plate, wherein the third accommodating space cooperates with the first accommodating space to define the combustion chamber.

7. The device according to claim 1, wherein the collection module comprises a temperature sensor, the one or more real-time state parameters comprise a real-time temperature value within the combustion chamber, and the one or more control parameters comprise a predetermined temperature threshold;
the control module comprises a comparison unit configured to compare the predetermined temperature threshold and the real-time temperature value so as to obtain a real-time temperature difference, and an output unit configured to determine a required size of the air vent corresponding to the real-time temperature difference based on a corresponding relationship between a preset temperature difference and the size of the air vent and then output a control instruction for adjusting the size of the air vent based on a current size of the air vent and the required size of the air vent.

8. A method for controlling a moxibustion device that comprises a box provided with at least one through-hole, and a lid detachably connected to the box and cooperating with the box to define a combustion chamber where moxa is burnt, the lid being provided with at least one opening which cooperates with the through-hole in the box to define an air vent of the combustion chamber, the method comprising:
acquiring one or more real-time state parameters of moxa within the combustion chamber;
outputting a control instruction based on the one or more real-time state parameters and one or more preset control parameters; and
adjusting a size of the air vent based on the control instruction.

9. The method according to claim 8, wherein the adjustment of the size of the air vent based on the control instruction comprises:
driving the lid to rotate with respect to the box based on the control instruction to adjust a size of an overlapping portion between the at least one through-hole in the box and the at least one opening in the lid, so as to adjust the size of the air vent.

10. The method according to claim 8, wherein prior to the acquisition of the one or more real-time state parameter of the moxa within the combustion chamber, the method further comprises:
establishing wireless connection with a terminal; and
receiving the one or more control parameters transmitted from the terminal and/or transmitting the one or more real-time state parameters to the terminal.

11. The method according to claim 10, further comprising:
detecting whether the moxibustion device is operating properly; and
transmitting a warning message to the terminal and/or turning off the moxibustion device when the moxibustion device is not operating properly.

12. The method according to claim 11, wherein prior to the detection of whether the moxibustion device is operating properly, the method further comprises:
determining, with a timepiece, whether a timing period of moxibustion based on the one or more control parameters has expired; and
transmitting an end reminder message to the terminal and/or turning off the moxibustion device when the timing period of moxibustion has expired.

13. The method according to claim 8, wherein the one or more real-time state parameters comprise a real-time temperature value within the combustion chamber, and the one or more control parameters comprise a predetermined temperature threshold; and
the outputting of the control instruction based on the one or more real-time state parameters and the one or more preset control parameters comprises:
comparing the predetermined temperature threshold and the real-time temperature value so as to obtain a real-time temperature difference;
determining a required size of the air vent corresponding to the real-time temperature difference based on a corresponding relationship between a preset temperature difference and the size of the air vent; and
outputting the control instruction for adjusting the size of the air vent based on a current size of the air vent and the required size of the air vent.

14. A system, comprising the moxibustion device according to claim 3, and a terminal wirelessly connected to the moxibustion device and configured to transmit one or more control parameters to the moxibustion device and/or receive one or more real-time state parameters transmitted from the moxibustion device.

15. The system according to claim 14, wherein the system further comprises a cloud server;
the terminal is further configured to transmit historical data of moxibustion to the cloud server; and
the cloud sever is configured to store the historical data of moxibustion transmitted from the terminal.

16. The system according to claim 14, wherein the moxibustion device further comprises a detection module electrically connected to the control module and configured to generate a warning message and/or a first turn-off instruction to turn off the moxibustion device when the moxibustion device is not operating properly.

17. The system according to claim 16, wherein the moxibustion device further comprises a timepiece electrically connected to the control module and configured to time moxibustion based on the one or more control parameters and to generate an end reminder message and/or a second turn-off instruction to turn off the moxibustion device when a timing period of moxibustion has expired.

18. The system according to claim 14, wherein the box comprises a first housing provided with the at least one through-hole, a partition, a second housing, a first accommodating space defined by the first housing and the partition, and a second accommodating space defined by the first housing and the partition, and a second accommodating space defined by the second housing and the partition, wherein the control module is mounted in the second accommodating space; and
wherein the lid comprises a third housing provided with the at least one opening, a top plate, and a third accommodating space defined by the third housing and a top plate, wherein the third accommodating space cooperates with the first accommodating space to define the combustion chamber.

19. The system according to claim 14, wherein the collection module comprises a temperature sensor, the one or more real-time state parameters comprise a real-time temperature value within the combustion chamber, and the one or more control parameters comprises a predetermined temperature threshold.

20. The system according to claim 14, wherein the control module comprises a comparison unit configured to compare the predetermined temperature threshold and the real-time temperature value so a s to obtain a real-time temperature difference, and an output unit configured to determine a required size of the air vent corresponding to the real-time temperature difference and the size of the air vent and then output a control instruction for adjusting the size of the air vent based on a current size of the air vent and the required size of the air vent.
